(19) United States
(12) Patent Application Publication
(10) Pub. No.: US 2023/0062549 A1
(43) Pub. Date: Mar. 2, 2023

(54) SYSTEM AND METHOD OF TRAINING A NEURAL NETWORK

(71) Applicant: Nokia Technologies Oy, Espoo (FI)

(72) Inventors: Dan Kushnir, Springfield, NJ (US); Matteo Sordello, Philadelphia, PA (US)

(21) Appl. No.: 17/409,997

(22) Filed: Aug. 24, 2021

(51) Int. Cl. G06N 3/08; G06K 9/62

(52) U.S. Cl. CPC G06N 3/08; G06K 9/6228; G06K 9/6259; G06K 9/6296

(57) ABSTRACT

A system and method for iteratively training a neural network are provided. The system and method may include extracting a subset of labeled data points from a pool set of labeled data points; populating, an anchor set of labeled data points with the extracted subset of labeled data points; using the anchor set of labeled data points as labeled inputs to partially train the neural network; selectively swapping, at least some of the labeled data points in the anchor set with at least some of the remaining labeled data points in the pool set; and, retraining the neural network using the anchor set of labeled data points as labeled inputs to the neural network.

### BACKGROUND

### Field

Various example embodiments relate generally to methods and apparatuses for active learning for deep learning training of neural networks using a training data set, wherein trained neural networks may be used to classify new data in a similar manner as the training data set.

### Related Art

In the field of machine learning, many scenarios involve neural networks that are organized as a set of layers, such as an input layer that receives an input, one or more hidden layers that process the input based on weighted connections with the neurons of a preceding layer, and an output layer that generates an output that may indicate a classification of the input. As an example, each input may be classified into one of N classes by providing an output layer with N neurons, where the neuron of the output layer having a maximum output indicates the class into which the input is classified.

Neural networks may be trained to classify data through a learning process. As an example involving fully-connected layers, each neuron of a layer is connected to each and every neuron of a preceding layer, and each connection includes a weight that is initially set to a value, such as a random value. Each neuron determines a weighted sum of the weighted inputs of the preceding layer and provides an output based on the weighted sum and an activation function, such as a linear activation, a rectified linear activation, a sigmoid activation, and/or a softmax activation. The output layer may similarly generate an output based on the weighted sum and an activation function.

A training data set of inputs with labels (for example, the expected classification of each input) is provided to train the neural network. Each input is processed by the neural network, wherein a backpropagation process is performed to adjust the weights of each layer such that the output is closer to the label. Some training processes may involve dividing the inputs of the training data set into mini-batches and performing backpropagation on an aggregate of the outputs for the inputs of each mini-batch. Continued training may be performed until the neural network converges, such that the neural network may produce output that is at least close to the label for each input. A neural network that is trained to perform discriminant analysis between two or more classes may form a decision boundary in an input space or sample space, wherein inputs that are on one side of the decision boundary are classified into a first class and inputs that are on another side of the decision boundary are classified into a second class. When the neural network is fully trained, new data may be provided, such as inputs without known labels, and the neural network may classify the new data based upon the training over the training data set.

The field of deep learning includes a significant number of hidden layers and/or a significant number of neurons, which may enable a more complex classification process, such as the classification of high-dimensionality input. The number of weights (also known as parameters) and/or the number of inputs in the training data set may be large, such that the training may take a long time to converge. An extended duration of training may delay the availability of a trained neural network, and/or may be computationally expensive, such as consuming significant computational resources such as processing capacity, memory capacity, network capacity, and/or energy usage to apply training until the neural network converges.

Neural networks have reached record performance in many fields, including computer vision and natural language processing. However, as the size of collected data increased dramatically over the past two decades, the effort of training neural networks is becoming a key challenge to advance the state-of-the-art. In particular, the optimization at the core of the training process and the annotation effort required in labelling massive data sets have become two major bottlenecks in the training of deep neural networks models.

### SUMMARY

Some example embodiments include an apparatus and methods for optimizing the training of neural networks. In some embodiments, one or more of the methods may be incorporated into an active learning framework or apparatus.

### BRIEF DESCRIPTION OF THE DRAWINGS

At least some example embodiments will become more fully understood from the detailed description provided below and the accompanying drawings, wherein like elements are represented by like reference numerals, which are given by way of illustration only and thus are not limiting of example embodiments and wherein:

FIG. 1 is a diagram of an apparatus according to some example embodiments.

FIG. 2 is a diagram of a neural network in according to some example embodiments.

FIG. 3 is a process flow diagram in according to some example embodiments.

FIG. 4 is a diagram of labeled data points according to some example embodiments.

FIG. 5 is a diagram of a logical view of steps 308 and 310 of process 300 of FIG. 3.

FIG. 6. is an diagram of a pseudo code algorithm in accordance with process 300 of FIG. 3.

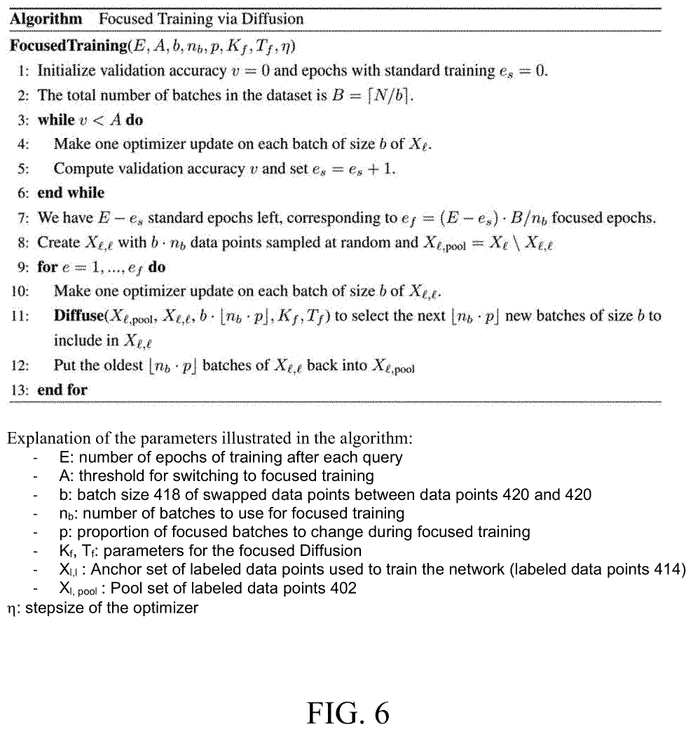

### DETAILED DESCRIPTION OF EXAMPLE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing at least some example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments are discussed herein as being implemented in a suitable computing environment. Although not required, example embodiments will be described in the general context of computer-executable instructions (e.g., program code), such as program modules or functional processes, being executed by one or more computer processors or CPUs. Generally, program modules or functional processes include routines, programs, objects, components, data structures, etc. that performs particular tasks or implement particular abstract data types.

In the following description, example embodiments will be described with reference to acts and symbolic representations of operations (e.g., in the form of flowcharts) that are performed by one or more processors (i.e., processing circuitry), unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

Example embodiments being thus described, it will be obvious that embodiments may be varied in many ways. Such variations are not to be regarded as a departure from example embodiments, and all such modifications are intended to be included within the scope of example embodiments.

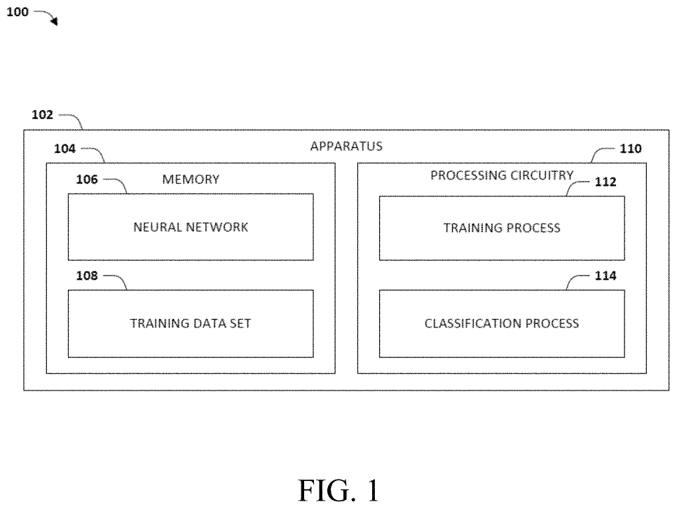

FIG. 1 is a diagram of an apparatus 102 according to some example embodiments.

In the example 100 of FIG. 1, the apparatus 102 includes a memory 104 that stores a neural network 106. The neural network 106 may include, for example, a set of neurons arranged as a sequence of layers, such as an input layer, one or more hidden layers, and an output layer. The neural network 106 may be organized according to various neural network models, such as a multilayer perceptron (MLP) model, a radial basis function (RBF) neural network, a convolutional neural network (CNN) model, a recurrent neural network (RNN) model, a deconvolutional network (DN) model, a deep belief network (DBN) model, a residual neural network (ResNet) model, a support vector machine (SVM) neural network model, and the like. In some example embodiments, the neural network 106 may include a hybrid of neural subnetworks of different types, such as a convolutional recurrent neural network (CRNN) model and/or generative adversarial networks (GANs), and/or an ensemble of two or more neural subnetworks of the same or different types, optionally including other types of learning models. The neural network 106 may be organized according to a set of hyperparameters, for example, the number of layers, the number of neurons in each layer, the types of layers (e.g., a fully connected layer, a convolutional layer, a max or average pooling layer, and a filter concatenation layer), the operating characteristics of each layer (e.g., a size or count of a filter of a convolutional layer, a padding size, a stride, and/or an activation function to be utilized to generate the output of the layer), and/or the inclusion of additional features (e.g., a long short term memory (LSTM) unit, a gated recurrence unit (GRU), and/or a skip connection). The input layer of the neural network 106 may include a number of neurons according to a dimensionality of an input. Similarly, the output layer of the neural network may include a number of neurons according to a dimensionality of an output. The memory 104 may store, for the neural network 106, a set of parameters, such as a weight of a connection between a neuron in a fully-connected layer and each neuron in a preceding layer of the neural network. In various types of deep neural networks, the number of layers and/or the number of neurons in each layer may be large. The present disclosure is not limited to these examples of neural networks, and may include neural networks of different types and/or organizational structures than the example embodiments discussed herein.

In the example 100 of FIG. 1, the memory 104 of the apparatus 102 also stores a training data set 108 including a set of inputs that may be provided to train the neural network 106. The training data set 108 may include labeled inputs, that is, inputs that are associated with a correct, desired, and/or anticipated output that the neural network 106 is to produce. For example, if the neural network 106 is configured to classify each input into one of two or more classes, then each input of the training data set 108 may include a label indicating the class into which the neural network 106 is to classify the input. In some embodiments, the training data set 108 may also include unlabeled inputs that are not yet associated with a label. In such embodiments, at least some of the unlabeled inputs may be selectively labeled (e.g., annotated with a label by a subject matter expert, human or automated), and then the newly labeled inputs may be used to further train/refine the performance of the neural network. In some example scenarios, the training data set 108 may be locally stored by the apparatus 102. In other example scenarios, the training data set 108 may be remote to the apparatus 102, such as stored by a remote database server, and the apparatus 102 may access the training data set 108 to train the neural network 106. In still other example scenarios, the training data set 108 may be provided to the apparatus 102 as live data, for example, data received from a sensor such as a camera.

In the example 100 of FIG. 1, the apparatus 102 includes processing circuitry 110. In some example embodiments, the processing circuitry 110 may include hardware such as logic circuits; a hardware/software combination, such as a processor executing software; or a combination thereof. For example, a processor may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry 110 may perform various aspects of or associated with the training, labeling, and/or processing of the neural network 106, including classifying new data using a neural network 106 that has been trained as discussed herein.

In some example embodiments and as shown in the example 100 of FIG. 1, the processing circuitry 110 may include a training process 112, such as an algorithm or a set of instructions that, when executed by a processor of the processing circuitry 110, causes the apparatus 102 to feed some of the training data set 108 into the neural network 106 to produce a trained neural network. The training process 112 may include, for example, a supervised training model, an unsupervised training model, and/or a reinforcement training model. The training process 112 may include a number of variations, for example, a mini-batch size, a number of epochs to be executed, a loss function, forms of normalization and/or regularization that may be applied during the training, and/or performance metrics that may be used to evaluate and validate the performance of the neural network 106. In some example embodiments, the training process 112 may utilize specialized hardware of the apparatus 102, such as a graphics processing unit (GPU) and/or a tensor processing unit (TPU). In some other example embodiments, the training process 112 may be performed by a distributed collection of computing devices, such as a cloud-based machine learning platform that distributes the training over a set of servers including the apparatus 102. In other example scenarios, the training may be performed on the apparatus 102 using general-purpose hardware, such as a central processing unit (CPU).

In the example 100 of FIG. 1, the processing circuitry 110 may also perform a classification process 114 to classify new data using the neural network 106 after the training by providing new data as an input of the neural network 106 and utilizing the output of the neural network 106, for example, as a classification of the input into one of at least two classes. The present disclosure is not limited to these forms of training and/or applying a neural network 106, and may include other forms of training and/or applications of neural networks 106 than are featured in the example embodiments discussed herein.

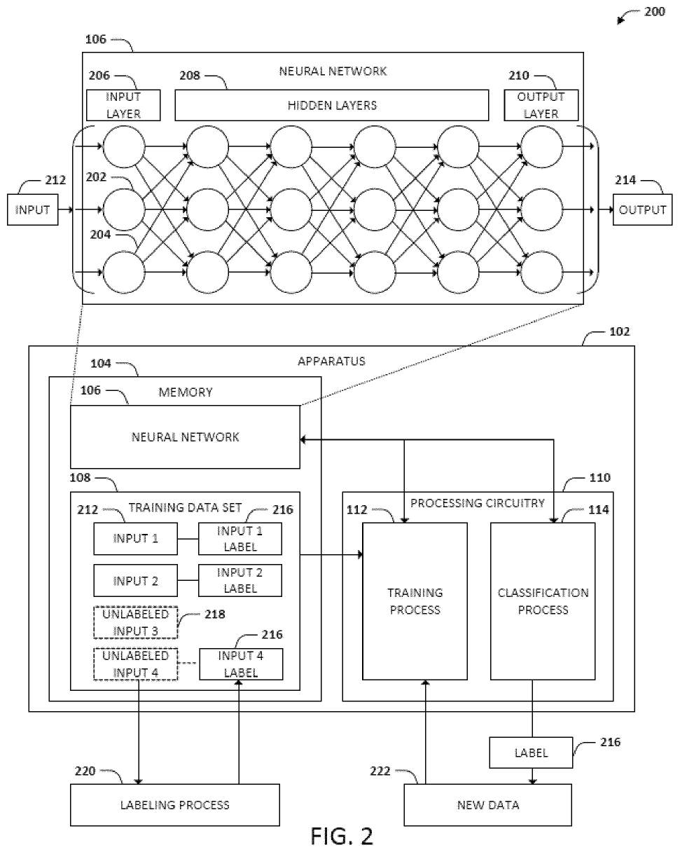

FIG. 2 is a diagram illustrating an example neural network that may be processed by an apparatus according to some example embodiments.

In the example 200 of FIG. 2, a neural network 106 is organized as a set of neurons 202 that are arranged in layers, where each neuron 202 of each layer has a connection 204 with each and every neuron 202 of a preceding layer of the neural network 106. Each connection 204 has a weight, for example, a floating-point value that indicates a magnitude of the output of the neuron 202 of the preceding layer that is received by the neuron 202 of the following layer. The layers of the neural network 106 include an input layer 206, a set of hidden layers 208, and an output layer 210. The neural network 106 may receive an input 212 that is provided as input to the input layer 206. The input 212 may have a variable dimensionality, and in some example embodiments, the dimensionality of the input 212 may match the number of neurons 202 in the input layer 206. Each neuron 202 of the input layer 206 may provide an output, optionally by invoking an activation function based on the input 212 to the neuron 202. The neurons 202 of the first hidden layer 208 may receive the output from each of the neurons 202 of the input layer 206, wherein each output is altered by the weight of the connection 204 between the neuron 202 of the hidden layer 208 and the neuron 202 of the input layer 206. Each neuron 202 of the hidden layer 208 may sum the weighted inputs from the input layer 206 and, optionally, may invoke an activation function based on the weighted sum to produce an output that is received by the neurons of the next hidden layer 208, and so on. In this manner, the input 212 may propagate through the layers of the neural network 106, eventually reaching the output layer 210. The neurons 202 of the output layer 210 may similarly receive a weighted sum from the last hidden layer 208, may optionally invoke an activation function on the weighted sum, and may provide output 214. As an example, if the neural network 106 is used for classification among three classes, each of the neurons 202 of the output layer 210 may provide output that represents whether the input 212 belongs to one of the classes. The output 214 for an input 212 may be interpreted by identifying which of the neurons 202 of the output layer 210 provides a larger output than any other neuron 202 of the output layer 210.

In the example 200 of FIG. 2, the apparatus 102 stores the neural network 106 in a memory 104, along with the training data set 108 including a number of inputs 108, some of which are associated with labels 216 and, in some embodiments, some of which are unlabeled input 218. The apparatus 102 also has access to a labeling process 220, for example, a service that may determine a label 216 that is to be associated with an unlabeled input 218. In some example scenarios, the labeling process 220 may be, for example, another machine learning service or model that identifies labels 216 for unlabeled inputs 218. In some example scenarios, the labeling process 220 may be, for example, one or more individuals who may be requested to select a label 216 for an unlabeled input 218. The apparatus 102 may selectively invoke the labeling process 220 for one or more of the unlabeled inputs 218, and, based upon receiving a label 216 from the labeling process 220 for the unlabeled input 218, may associate the label 216 with the formerly unlabeled input 218 to expand the number of labeled inputs 212 of the training data set 108.

In the example 200 of FIG. 2, the apparatus 102 includes processing circuitry 110 that includes a training process 112 to train the neural network 106 using the training data set 108. The processing circuitry 110 also includes a classification process 114 that utilizes the trained neural network 116 to classify new data 222. For example, when new data 222 is available to the apparatus 102 that may not be associated with a label 216, the apparatus 102 may provide the new data 222 as input 212 to the neural network 106 and may provide the output 214 as a label 216 to be associated with the new data 222, for example, a classification of the new data 222 selected from a set of classes. In some embodiments, the classified new data 222 may be added to the training data set 108.

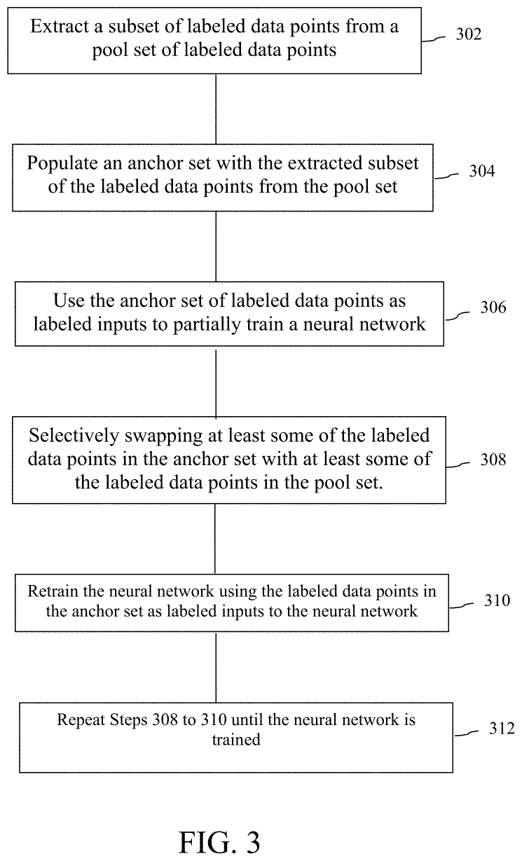

FIG. 3 is an illustration of an example process 300 for training a neural network, such as the neural network 116, in accordance with some embodiments.

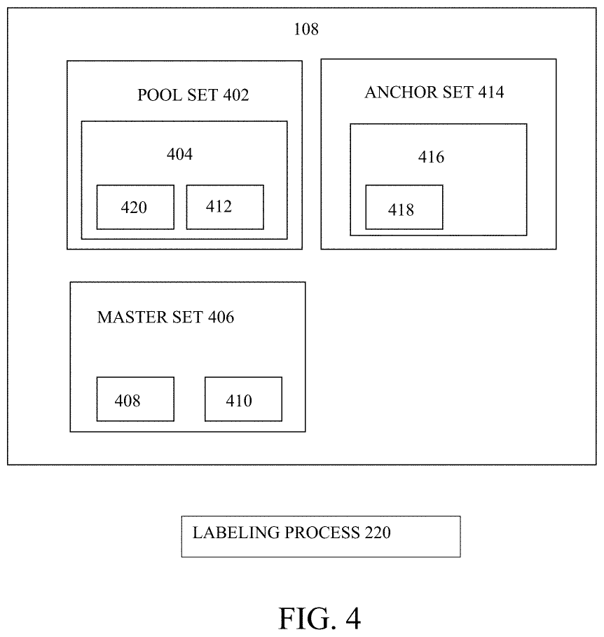

The process begins with step 302. Step 302 includes extracting a subset of labeled data points from a pool set of labeled data points. For example, as shown in FIG. 4, the training data set 108 may include a pool set 402 of labeled data points 404. In one embodiment, the labeled data points 404 may be sourced from a master data set 406. Master data set 406 may include a set of unlabeled data points 408, and in some embodiments, may also include a set of labeled data points 410. A labeling process, such as the example labeling process 220 of FIG. 1, may be used to periodically and selectively label at least some the unlabeled data points 408. The labeled data points resulting from the labeling process 220 may be saved as labeled data points 410. At least some of the labeled data points 410 may be used to populate the labeled data set 404 of the pool set 402.

A processing unit, such as the processing circuitry 110 of apparatus 102, may be configured to extract at least a subset 412 of labeled data points from the labeled data points 404 in the pool set 402. The subset 412 of labeled data points that are extracted from the pool set 402 in step 302 may be selected in several ways. In one embodiment, the processing circuitry 110 may use random selection to select and extract the subset 412 from the labeled data points 404 in pool the set 402. In other embodiments, the selection and extraction may be based upon a predetermined criteria, or a combination of predetermined criteria and random selection.

Step 304 includes populating an anchor set with the extracted subset of the labeled data points from the pool set. For example, in some embodiments, the processing circuitry 110 may be configured to create and populate the anchor set 414 with the extracted subset of labeled data points 412 for the first time in step 304 as appropriate. In FIG. 4, the number of labeled data points 412 that are extracted from the pool set 402 and are populated/moved into the anchor set 414 are depicted as labeled data points 416. The number of labeled data points 412 that are extracted from the labeled pool set and populated into the anchor set 414 may be based on a predetermined fraction of the number of labeled data points that are in the pool set 402.

Step 306 includes using the anchor set of labeled data points as labeled inputs to partially train a neural network. For example, in some embodiments the processing circuitry 110 may be configured to use the labeled data points 416 in the anchor set 414 to train a neural network, such as neural network 106 depicted and described in FIGS. 1 and 2.

Step 308 includes selectively swapping at least some of the labeled data points in the anchor set with at least some of the labeled data points in the pool set. For example, the processing circuitry 110 may be configured to selectively swap at least some of the labeled data points 418 from the labeled data set 416 in the anchor set 414 that were used as the labeled inputs to partially train the neural network 106 with at least some of the remaining labeled data points 420 in the pool set 402 such that the overall sizes of the remaining labeled data points 420 (after extraction of the labeled data points 412 in step 302) in the pool set 402 and the anchor set 414 remain the same after the swapping in step 308. The result of step 308 is that at least some of the labeled data points in the anchor set 414 that were used to train the neural network 106 are replaced with a new set of labeled data points that are selected from the remaining labeled data points 420 in the pool set 402. Furthermore, the labeled data points in the anchor set 414 that were replaced by the newly added labeled data points from the pool set 402 are moved back into the pool set 402, thus completing a two-way transfer process between the pool set 402 and the anchor set 414 such that the overall size of the labeled data points 420 in the pool set 402 and in of the labeled data points 416 in the anchor set 414 remain the same.

Step 310 includes retraining the neural network using the labeled data points 416 in the anchor set 414 as labeled inputs to the neural network, in a manner that may be similar to the training performed in step 306;

Step 312 includes repeating step 308 (selective swapping) and step 310 (retraining) for at least one of a preselected number of iterations or until a specified learning rate criteria for training the neural network 106 is met.

In some embodiments, the process includes selecting, by the processing circuitry, at least some of the labeled data points in the anchor set to be swapped with at least some of the selected labeled data points in the pool set based on a number of times respective data points in the anchor set have been used as labeled inputs to train the neural network.

In some embodiments, example process 300 may advantageously be integrated into an active learning framework by selecting, by the processing circuitry, one or more unlabeled data points from a set of unlabeled data points, annotating the selected one of more unlabeled data points with labels to create a set of annotated data points with labels, adding, by the processing circuitry, at least one of the annotated data points to the pool set of labeled data points; and, repeating (e.g., as in step 312), by the processing circuitry, step 308 and step 310 for at least one of a preselected number of iterations or until a specified learning rate is met.

The process 300 depicted in FIG. 3 may be understood as an optimization technique. The process is used to select the points that are more relevant to the training of the model at each moment, in the sense of introducing the largest change to the DNN model, thereby speeding up the training of the neural network over conventional approaches with labeled datapoints that have the greatest impact.

Standard DNN methods train the model by simply looping for a certain number of epochs on all the data points uniformly. This does not consider the fact that not all data that have been selected have the same importance during different stages of training. In the present disclosure the training points that are used for training the neural network are selected based on a focused training method that is related to the concept of importance sampling but is computationally less expensive (as selectively fewer and relatively most impactful labeled data points are used for training). The focused training method, as applied using a diffusion process on the graph constructed from the penultimate layer representation of labelled data improves conventional approaches to importance sampling. Although conventional importance sampling is a popular tool to accelerate training by selecting the points that are more relevant to the model at each stage of training, it relies upon a metric related to the norm of the gradient loss function. However, the explicit computation of those gradients is often infeasible in practice, due to the extreme number of parameters in the model. In the present disclosure, it has been found that, even though diffusion does not look directly at the gradient for the data points that it selects, it still chooses points that score very high according to such metric.

The selective swapping of step 308 that is used to select new labeled data points for training the neural network is now described in greater detail. In some embodiments, step 308 of selectively swapping at least some of the labeled data points 418 in the anchor set 414 with at least some of the labeled data points 420 in the pool set 402 such that the respective sizes of the anchor set and the pool set (after the initial extraction) are unchanged comprises constructing a proximity graph based on similarities of output of a hidden layer (e.g., the penultimate layer) of the neural network for each of the labeled inputs used to train the neural network. In this embodiment, the processing circuitry 110 may be configured to create the proximity graph based on the output of the selected hidden layer (i.e., the penultimate layer) of the neural network for the labeled data points that were used as labeled inputs into the neural network. The processing circuitry 110 may be further configured for selecting, at least some of the labeled data points in the pool set to be swapped with at least some labeled data points in the anchor set based on a graph-diffusion process of the labels of the data points of the anchor set to the data points of the pool set.

Intuitively, the new selection of labeled data points for training the neural network in accordance with various aspects of the disclosure may be understood as a diffusion based sampling method that aims at selecting new labeled data points from the pool set 402 to be used for training with that are going to make the model performance improve faster. In order to do so, as stated previously, step 308 includes, at the outset, creating a nearest neighbor graph representation of the training set of labeled data points that were previously used to train the neural network (labeled data points 416 in FIG. 4). At a step ‘I’ of the diffusion the currently selected batch of labelled points that were used to train the neural network diffuse their labels into the remaining training points whose labels are omitted in this process (e.g., the remaining labeled data points 420 in pool set 402). Then the nodes (i.e. data points) with the most uncertain labels are selected among those remaining training points (labeled data points 420) to serve as new training labeled data points in the next iteration of re training neural network (step 310 in FIG. 3). The newly selected labeled data points from the remaining labeled datapoints 420 are swapped with the same number of data points (labeled data points 418 in the labeled datapoints 416), such that the overall size of next batch of data points used to train the neural network remains the same. A predetermined parameter may be used to control the rate of replacement of the existing batch (i.e., labeled data points 418) with new ley selected points (step 308) from the remaining labeled data points 420 in the pool set 402.

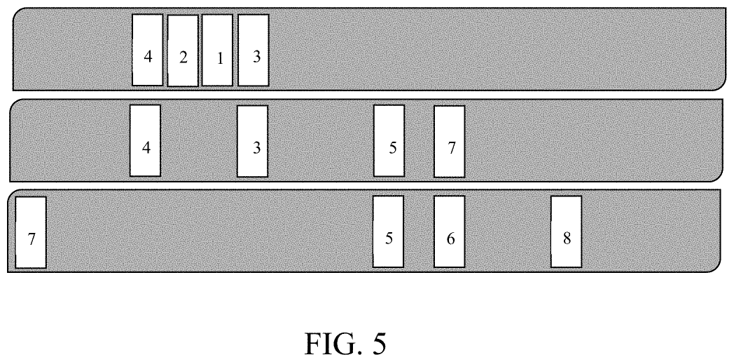

More particularly, in step 302 and step 304 the process starts randomly dividing the labelled data set (pool set 402) into two groups (labeled data points 420 and extracted data points 416), one in which the labels are maintained (extracted data points 416), and one in which the process in effect assumes that it still does not know them (remaining data points 420). The real training (backpropagation of the loss and SGD update) is performed only using labeled data points 416, while the set of remaining labeled data points 420 is used as the pool set 402 to query the new data to selectively add to labeled data points 416 in step 308). The same number of data points) that are newly added to labeled data points 416 from the remaining labeled data points 420 are also put back (labeled data points 418) into the remaining data points 420, to keep the size of these two sets (416, 420) constant. This focused querying is made in batches, and two parameters of the procedure may be used to determine the size of labeled data set 416 and labeled data set 420. In the FIG. 5 illustrates the swapping performed in step 308. The gray shaded portion may be understood as the whole set of labelled data points so far, and the numbered boxes represent the batches of data points that are used for focused training. After training on the four batches of labeled data points (data points 416), get two new batches from remaining data points 420 and swap them with the two oldest batches of labeled data points 418. This procedure may continue (steps 312) until the process has performed, for example, the same number of updates that would normally be performed by just looping on the whole labelled data for E epochs.

The underlying idea of this step (step 308) is that not all remaining data points 420 that are in the pool set 402 are necessarily useful for training at the current stage, so an extra use of diffusion based selection allows the process 300 to distinguish the points that are more relevant, and use those to perform more updates/retraining of the model.

FIG. 5 illustrates a pseudo code algorithm for performing the steps illustrated in flow process 300 of FIG. 3 in accordance with the description above.

1. A method of training a neural network, the method comprising:
a) extracting, by a processing circuitry, a subset of labeled data points from a pool set of labeled data points;
b) populating, by the processing circuitry, an anchor set of labeled data points with the extracted subset of labeled data points;
c) using, by the processing circuitry, the anchor set of labeled data points as labeled inputs to partially train the neural network;
d) selectively swapping, by the processing circuitry, at least some of the labeled data points in the anchor set that are used as the labeled inputs to train the neural network with at least some of the labeled data points in the pool set of labeled data points such that the size of the anchor set and the pool set are unchanged;
e) retraining, by the processing circuitry, the neural network using the anchor set of labeled data points as labeled inputs to the neural network;
f) repeating, by the processing circuitry, step d) and step e) for at least one of a preselected number of iterations or until a specified learning rate is met.

2. The method of claim 1, the method further comprising:
the step d) of selectively swapping at least some of the labeled data points in the anchor set with at least some of the labeled data points in the pool set of labeled data points such that the size of the anchor set and the pool set are unchanged further includes:
constructing, by the processing circuitry, a proximity graph based on similarities of output from a hidden layer of the neural network for each of the labeled inputs used to train the neural network;
analyzing, by the processing circuitry, the proximity graph and selecting, at least some of the labeled data points in the pool set to be swapped with at least some labeled data points in the anchor set based on a graph-diffusion process of the labels of the data points of the anchor set to the data points of the pool set.

3. The method of claim 2, further comprising:
selecting, by the processing circuitry, at least some of the labeled data points in the anchor set to be swapped with at least some of the selected labeled data points in the pool set based on a number of times respective data points in the anchor set have been used as labeled inputs to train the neural network.

4. The method of claim 1, further comprising:
the step a) of extracting, by the processing circuitry, the subset of labeled data points from the pool set of labeled data points further includes:
randomly selecting, by the processing circuitry, from the pool set, at least some of the subset of labeled data points that are extracted from the pool set.

5. The method of claim 1, wherein the hidden layer of the neural network is the penultimate layer that is connected to an output layer of the neural network.

6. The method of claim 1, wherein the number of labeled data points that extracted from the pool set and are populated into the anchor set is based on a predetermined fraction of the starting size of the pool set.

7. The method of claim 1, further comprising:
selecting, by the processing circuitry, one or more unlabeled data points from a set of unlabeled data points;
annotating, by the processing circuitry, the selected one of more unlabeled data points with labels to create a set of annotated data points with labels;
adding, by the processing circuitry, at least one of the annotated data points to the pool set of labeled data points; and,
repeating, by the processing circuitry, step d) and step e) for at least one of a preselected number of iterations or until a specified learning rate is met.

8. A system for training a neural network, the system comprising:
at least one processing circuitry; and
at least one memory including computer program code;
the at least one memory and the computer program code configured to, with the at least one processing circuitry, cause the system to:
a) extract a subset of labeled data points from a pool set of labeled data points;
b) populate an anchor set of labeled data points with the extracted subset of labeled data points;
c) use the anchor set of labeled data points as labeled inputs to partially train the neural network;
d) selectively swap at least some of the labeled data points in the anchor set that are used as the labeled inputs to train the neural network with at least some of the labeled data points in the pool set of labeled data points such that the size of the anchor set and the pool set are unchanged;
e) retrain the neural network using the anchor set of labeled data points as labeled inputs to the neural network;
f) repeat step d) and step e) for at least one of a preselected number of iterations or until a specified learning rate is met.

9. The system of claim 8, wherein:
the step d) of selectively swapping at least some of the labeled data points in the anchor set with at least some of the labeled data points in the pool set of labeled data points such that the size of the anchor set and the pool set are unchanged further includes:
constructing, by the processing circuitry, a proximity graph based on similarities of output from a hidden layer of the neural network for each of the labeled inputs used to train the neural network;
analyzing, by the processing circuitry, the proximity graph and selecting, at least some of the labeled data points in the pool set to be swapped with at least some labeled data points in the anchor set based on a graph-diffusion process of the labels of the data points of the anchor set to the data points of the pool set.

10. The system of claim 9, wherein the system is further configured to:
select at least some of the labeled data points in the anchor set to be swapped with at least some of the selected labeled data points in the pool set based on a number of times respective data points in the anchor set have been used as labeled inputs to train the neural network.

11. The system of claim 8, wherein:
the step a) of extracting the subset of labeled data points from the pool set of labeled data points further includes:
randomly selecting from the pool set, at least some of the subset of labeled data points that are extracted from the pool set.

12. The system of claim 8, wherein the hidden layer of the neural network is the penultimate layer that is connected to an output layer of the neural network.

13. The system of claim 8, wherein the number of labeled data points that extracted from the pool set and are populated into the anchor set is based on a predetermined fraction of the starting size of the pool set.

14. The system of claim 8, wherein:
the at least one memory and the computer program code are further configured to, with the at least one processing circuitry, cause the system to:
select one or more unlabeled data points from a set of unlabeled data points;
annotate the selected one of more unlabeled data points with labels to create a set of annotated data points with labels;
add at least one of the annotated data points to the pool set of labeled data points; and,
repeat step d) and step e) for at least one of a preselected number of iterations or until a specified learning rate is met.
